(19) United States
(12) Patent Application Publication
(10) Pub. No.: US 2023/0415460 A1
(43) Pub. Date: Dec. 28, 2023

(54) FILM

(71) Applicant: Pilkington Group Limited, Nr. Ormskirk Lancashire (GB)

(72) Inventors: Jonathan Barclay DIXON, Ormskirk Lancashire (GB); Joseph Jeremy BOOTE, Ormskirk, Lancashire (GB)

(73) Assignee: Pilkington Group Limited, Nr. Ormskirk Lancashire (GB)

(21) Appl. No.: 18/253,228

(22) PCT Filed: Nov. 19, 2021
(86) PCT No.: PCT/GB2021/052999

§ 371 Date: May 17, 2023

(30) Foreign Application Priority Data
Nov. 19, 2020 (GB) 2018219.2

(51) Int. Cl. B32B 17/10; G02F 1/1339; G02F 1/1341

(52) U.S. Cl. CPC B32B 17/10504; B32B 17/10807; B32B 17/10761; B32B 17/10779; B32B 17/10174; B32B 17/10036; G02F 1/13392; G02F 1/1341; B32B 2307/736; G02F 1/13725

(57) ABSTRACT

A film contains an electrically actuated liquid having variable optical opacity under the influence of an electric field. The film comprises first and second spaced apart substrates defining a first cavity therebetween in which some or all of the liquid is contained. The film also comprises a liquid trap in fluid communication with the first cavity via a first opening. The liquid trap contains liquid that may flow from the first cavity through the first opening due to the volume of first cavity decreasing. The film may be included in a laminated glazing. A method of preparing a cell for a liquid is also described, and such a cell may be part of a film having variable optical opacity.

The present invention relates to a film for containing a liquid, in particular a film having variable optical opacity under the influence of an electric field, to a method of preparing a cell for containing a liquid, in particular a liquid having variable optical opacity under the influence of an electric field, and to a laminated glazing containing a film, in particular a light control film.

It is known to produce a laminated glazing comprising two sheets of glass joined by an interlayer structure comprising a sheet of adhesive interlayer material, for example a sheet of polyvinyl butyral (PVB).

To join the sheets of glass, an unlaminated stack is prepared and then subjected to suitably high temperature and pressure to cause the sheet of adhesive interlayer material to flow thereby contacting the sheets of glass. For this reason, such sheets of adhesive interlayer material are sometimes referred to as hot melt adhesives in the art.

It is known that certain materials when heated shrink. One such material is polyethylene terephthalate (PET). Such a material, when heated to temperatures in excess of 50° C., for example around ° C. to 150° C., has a tendency to shrink.

The use of PET films is well known in the field of lamination. Often a PET film is used as a carrier sheet for an infrared radiation reflection coating, and the coated PET film is typically incorporated into a laminated glazing such as a vehicle windscreen by having a sheet of adhesive interlayer material such as PVB on opposite sides of the coated PET film, and glass sheets either side.

PET films are also used in other fields as a substrate for an electrically actuated material. For example, it is known to have a layer of liquid crystal material between two sheets of PET, see for example U.S. Pat. No. 4,505,546 and WO2019209029A1. Such films can function as light control films.

In such films, it is known that spacers such as glass spheres are used to achieve the desired cell gap for the liquid crystal material.

There is however a problem with such films containing a liquid such as a liquid crystal material, when they are incorporated into a laminated glazing of the type described above.

US2018/0157072A1 describes a liquid crystal cell having a sealing material that does not lose sealability even in the case where a plastic substrate is largely deformed as it is stretched or contracted.

US2019/0107742A1 describes a liquid crystal film cell including an expansion control layer having a high-temperature expansion coefficient different from that of the base film of the liquid crystal film cell.

US2021/0208445A1 describes a method for manufacturing a laminated glass whereby, in a laminated glass comprising a liquid crystal film sandwiched therein and having a three-dimensionally curved surface shape, the formation of wrinkles in the liquid crystal film can be suppressed.

US2021/146660A1 describes a vehicle window pane having a plate-like window pane body which has an outer side which faces the surroundings of the vehicle and an inner side which faces away from the outer side and to which a composite is connected, the composite having a layer structure which may have multiple layers disposed one on top of the other, one of the layers having a liquid crystal arrangement having two films and a liquid crystal cell disposed between the two films, and another one of the layers being a polarizer layer. At least one layer of the layer structure can be a compensation layer whose area is smaller than the area of the liquid crystal arrangement, the liquid crystal cell thus having an edge portion which is thicker than a central portion covered by the compensation layer.

Using typically high temperatures (and pressure) to form the laminated glazing, the PET substrates of the film shrink upon being heated. This shrinkage causes the volume of the cell containing the liquid crystal material to decrease, with a resultant pressure increase inside the cell. This pressure increase may be sufficient to cause the cell walls to rupture, whereby liquid may escape. The present invention addresses the above mentioned problems.

Accordingly, the present invention provides from a first aspect a film containing a liquid, the film comprising a first substrate joined to a second substrate, the first substrate being spaced apart from the second substrate to define a first cavity in which at least a portion of the liquid is contained, wherein upon applying a suitable electric field between the first and second substrates, the film changes from a first optical opacity to a second optical opacity, characterised in that the film comprises a liquid trap configured to be in fluid communication with the first cavity via at least a first opening, the liquid trap being arranged to contain liquid that flows from the first cavity through the first opening.

Such a film may be used as a light control film because the liquid in the first cavity has variable optical opacity depending upon the electric field applied between the first and second substrates of the film.

Light control may be achieved by scattering and/or absorption and/or polarization of visible light.

Optical opacity may be determined by measuring the attenuation of a light beam passing through the film at normal incidence to the first or second substrate.

As the pressure inside the first cavity is increased, which may be due to the volume of the first cavity decreasing due to being heated, and/or due to pressure being applied to a major surface of one or both of the substrates during a lamination process to include the film in a laminated glazing, some of the liquid is able to be contained by the liquid trap thereby preventing the film from rupturing. The liquid trap may also help maintain a uniform spacing of the first and second substrates such that the liquid in the first cavity has a constant thickness, or substantially constant thickness across the first cavity, such that at a particular applied electric field, the uniformity of the optical opacity of the cell is improved.

Preferably at least one of the first substrate and the second substrate has an electrically conductive, preferably optically transparent, coating on at least a portion of a major surface thereof. The electrically conductive coating may be used to apply the electric field between the first and second substrates.

Preferably both the first and second substrate has an electrically conductive, preferably optically transparent, coating on at least a portion of a major surface thereof.

Preferably the film comprises a first polarisation layer arranged to adjust a state of polarisation of a light beam passing through the film. Preferably the liquid trap comprises a second cavity and liquid that passes through the first opening is containable in the second cavity.

Preferably the liquid trap comprises a liquid absorber for containing liquid that passes through the first opening therein. That is, liquid that flows or passes through the first opening is contained in the liquid absorber. A suitable liquid absorber is a sponge.

Preferably the first and/or second substrate comprises a heat shrinkable material, in particular a plastic or a polyester. Suitable heat shrinkable material for the first and/or second substrate includes polyethylene terephthalate (PET), polyethylene naphthalate (PEN), polycarbonate (PC) and triallyl-cyanurate (TAC).

Preferably the liquid comprises a liquid crystal material, in particular a guest host liquid crystal material.

Preferably the first substrate is joined to the second substrate by a first seal. The first seal may delimit the first cavity. Preferably the first seal is an adhesive seal, in particular a heat curable adhesive seal and/or an ultraviolet radiation curable adhesive seal. Suitable material for the first seal includes epoxy-resin systems.

Preferably film according to any of the preceding claims, wherein the first substrate is spaced apart from the second substrate by one or more spacer between the first and second substrates.

Suitable spacers include glass spheres or the like.

In some embodiments the liquid trap comprises a sponge and a second cavity, and the sponge is enclosed within the second cavity.

In some embodiments wherein the liquid trap comprises a second cavity, it is preferred that the second cavity contains a fluid, preferably a gas or a liquid such as some of the liquid.

In some embodiments wherein the liquid trap comprises a second cavity, preferably the internal pressure inside the second cavity is less than atmospheric pressure.

Preferably the second cavity may be at a vacuum.

In some embodiments wherein the liquid trap comprises a second cavity, the second cavity is preferably be configured as a channel having a length, a width and a height, the height of the channel being determined the spacing of the first and second substrates of the film. Preferably the width of the channel is less than a width and/or a length of the first cavity, more preferably the width of the channel is less than ten times or less than twenty time or less than thirty times the width and/or length of the first cavity.

Preferably the channel comprises at least a first straight portion.

Preferably the channel comprises a meandering portion.

In some embodiments wherein the liquid trap comprises a second cavity, preferably the second cavity is configured as an expansion vessel to compensate for pressure changes inside the first cavity.

The expansion vessel has at least a first wall portion and preferably the first wall portion of the expansion vessel is movable and/or flexible.

Preferably the first wall portion of the expansion vessel is located inside the second cavity.

The first wall portion may define the second cavity and may be flexible and/or movable such that the second cavity is the expansion vessel and functions like a bladder.

When the first wall portion is movable and/or flexible and inside the second cavity, the first wall portion acts as a diaphragm for the expansion vessel.

In some embodiments the first opening is configured such that for a predetermined pressure inside the first cavity, liquid is inhibited from flowing from the first cavity to the liquid trap. The predetermined pressure may be determined by routine experimentation.

Preferably above the predetermined pressure inside the first cavity, liquid flows through the first opening to the liquid trap.

Preferably the opening is configured to have a size such that for a predetermined pressure the liquid does not flow through the opening.

Preferably a barrier covers the first opening, the barrier being configured to be ruptured or removed from the first opening when the pressure inside the first cavity exceeds the predetermined pressure. When the barrier no longer covers the first opening, liquid flows through the first opening to the liquid trap.

In embodiments when the first substrate is joined to the second substrate by a first seal, preferably the first opening is an opening in the first seal.

In embodiments when the liquid trap comprises a second cavity and liquid that passes through the first opening is containable in the second cavity, it is preferred that the second cavity is between the first and second substrates.

Preferably the second cavity is delimited by a second seal. Preferably at least a portion of the first seal delimits the second cavity.

In some embodiments the first and/or second substrate has a thickness less than 1 mm, preferably between 10 μm and 900 μm, more preferably between 50 μm and 500 μm.

In some embodiments the first substrate is spaced apart from the second substrate by less than 500 μm, preferably less than 400 μm or less than 300 μm or less than 200 μm or less than 100 μm or less than 50 μm.

In some embodiments the first substrate is spaced apart from the second substrate by more than 5 μm, preferably more 10 μm or more than 20 μm or more than 30 μm or more than 40 μm or more than 50 μm.

In some embodiments the film has a thickness less than 1000 μm, preferably between 50 μm and 500 μm.

In some embodiments the first substrate is joined to a first sheet of adhesive interlayer material arranged such that the first sheet of adhesive interlayer faces away from the first cavity. Suitable adhesive interlayer material comprises polyvinyl butyral (PVB), acoustic modified PVB, a copolymer of ethylene such as ethylene vinyl acetate (EVA), polyurethane (PU), poly vinyl chloride (PVC), a copolymer of ethylene and methacrylic acid (EMA) or a liquid curable resin such as Uvekol.

In some embodiments the second substrate is joined to a second sheet of adhesive interlayer material arranged such that the second sheet of adhesive interlayer faces away from the first cavity. Suitable adhesive interlayer material comprises polyvinyl butyral (PVB), acoustic modified PVB, a copolymer of ethylene such as ethylene vinyl acetate (EVA), polyurethane (PU), poly vinyl chloride (PVC), a copolymer of ethylene and methacrylic acid (EMA) or a liquid curable resin such as Uvekol.

In some embodiments the first substrate is joined to a first sheet of adhesive interlayer material and the second substrate is joined to a second sheet of adhesive interlayer such that the first cavity is between the first and second sheets of adhesive interlayer material. Suitable adhesive interlayer material comprises polyvinyl butyral (PVB), acoustic modified PVB, a copolymer of ethylene such as ethylene vinyl acetate (EVA), polyurethane (PU), poly vinyl chloride (PVC), a copolymer of ethylene and methacrylic acid (EMA) or a liquid curable resin such as Uvekol. The material of the first and second sheets of adhesive interlayer material may be the same or different.

In some embodiments wherein at least one of the first and second substrates has an electrically conductive coating on at least a portion of a major surface thereof, the respective electrically conductive coating preferably faces the first cavity.

Preferably the first substrate has an electrically conductive coating on at least a portion of a major surface facing the first cavity.

Preferably the second substrate has an electrically conductive coating on at least a portion of a major surface facing the first cavity.

Preferably the first substrate has an electrically conductive coating on at least a portion of a major surface facing the first cavity and the second substrate has an electrically conductive coating on at least a portion of a major surface facing the first cavity.

Preferably the or each electrically conductive coating is optically transparent.

In some embodiments the film is joined to a first sheet of glazing material by a first adhesive layer or a first sheet of adhesive interlayer material. Suitable adhesive interlayer material comprises polyvinyl butyral (PVB), acoustic modified PVB, a copolymer of ethylene such as ethylene vinyl acetate (EVA), polyurethane (PU), poly vinyl chloride (PVC), a copolymer of ethylene and methacrylic acid (EMA) or a liquid curable resin such as Uvekol. The adhesive layer may be a pressure sensitive adhesive or a layer of glue such as a polyurethane, polypropylene, polyvinyl acetate, or the like. In such embodiments the film is preferably part of a laminated glazing.

In some embodiments the film is joined to a first sheet of glazing material by a first adhesive layer or a first sheet of adhesive interlayer material on one side and to a second sheet of glazing material by a second adhesive layer or second sheet of adhesive interlayer material on the opposite side. Suitable adhesive interlayer material comprises polyvinyl butyral (PVB), acoustic modified PVB, a copolymer of ethylene such as ethylene vinyl acetate (EVA), polyurethane (PU), poly vinyl chloride (PVC), a copolymer of ethylene and methacrylic acid (EMA) or a liquid curable resin such as Uvekol. The adhesive layer may be a pressure sensitive adhesive or a layer of glue such as a polyurethane, polypropylene, polyvinyl acetate, or the like. In such embodiments the film is preferably part of a laminated glazing.

In embodiments where the film comprises a polarisation layer, preferably the polarisation layer is joined to the film by an adhesive layer or a sheet of adhesive interlayer material. In such embodiments, preferably the polarisation layer is between a first adhesive layer or a first sheet of adhesive interlayer material on one side a second adhesive layer or second sheet of adhesive interlayer material on the opposite side.

In some embodiments optical opacity relates to the visible light transmission (Illuminant D65 10° Observer) through the film at normal incidence to the first or second substrate.

From a second aspect the present invention provides a method of preparing a cell for a liquid, the cell comprising a first substrate joined to a second substrate, the first and/or second substrate comprising a heat shrinkable material; the method comprising the steps: (i) providing the first substrate; (ii) positioning the second substrate on the first substrate such that the first substrate is spaced apart from the second substrate; (iii) forming the cell by joining the second substrate to the first substrate to form a cavity having a first volume; and (iv) heating the cell formed at step (iii) to cause the first volume of the cavity to decrease to a second volume.

The first volume and the second volume may be measured using standard volumetric techniques.

The cell is suitable for containing an electrically actuated liquid, the electrically actuated liquid having variable optical opacity under the influence of an electric field.

Preferably after step (i) and before step (ii), one or more spacers is positioned on the first substrate such that following step (ii), the first substrate is spaced apart from the second substrate by at least one of the one or more spacers. Preferably following step (iii) at least one of the one or more spacers is contained in the cavity.

Preferably the cell formed at step (iii) has at least one hole therein in fluid communication with the cavity and following step (iv) liquid is introduced into the cavity via the hole, after which the hole is sealed thereby sealing liquid in the cavity of the cell. The hole may be in a major surface of the first and/or second substrate. The hole may be in a seal that delimits the cavity. It is preferred that the liquid introduced into the cavity via the hole completely fills the cavity.

Preferably the liquid is selected such that when the liquid is in the cavity, upon applying a suitable electric field between the first and second substrates, the film changes from a first optical opacity to a second optical opacity.

In some embodiments the liquid comprises a liquid crystal material, in particular a guest host liquid crystal material.

In other embodiments, after step (i) a first amount of liquid is positioned on the first substrate, the first amount of liquid having a volume less than the first volume of the cavity.

Preferably following step (iv) the first amount of liquid fills the cavity having the second volume.

In some embodiment the first and/or second substrate comprises a plastic or a polyester, preferably polyethylene terephthalate (PET), polyethylene naphthalate (PEN), polycarbonate (PC) or triallyl-cyanurate (TAC).

In some embodiments the heating during step (iv) is part of a lamination process whereby the cell is laminated to at least one sheet of glazing material by at least one sheet of adhesive interlayer material.

In some embodiments the heating during step (iv) is part of a pre-processing step such that following step (iv), the heat processed cell is used as a component of a laminated glazing comprising at least one sheet of glazing material and at least one sheet of adhesive interlayer material, the cell being joined to the at least one sheet of glazing material by the at least one sheet of adhesive interlayer material.

Suitable glazing material includes glass, in particular soda-lime-silicate glass. A typical soda-lime-silicate glass composition is (by weight), SiO₂ 69-74%; Al₂O₃ 0-3%; Na₂O 10-16%; K₂O 0-5%; MgO 0-6%; CaO 5-14%; SO₃ 0-2%; Fe₂O₃ 0.005-2%. The glass composition may also contain other additives, for example, refining aids, which would normally be present in an amount of up to 2%. The soda-lime-silicate glass composition may contain other colouring agents such as Co₃O₄, NiO and Se to impart to the glass a desired colour when viewed in transmitted light. The transmitted glass colour may be measured in terms of a recognised standard such as BS EN410.

Suitable adhesive interlayer material comprises polyvinyl butyral (PVB), acoustic modified PVB, a copolymer of ethylene such as ethylene vinyl acetate (EVA), polyurethane (PU), poly vinyl chloride (PVC), a copolymer of ethylene and methacrylic acid (EMA) or a liquid curable resin such as Uvekol.

In some embodiments of the second aspect of the present invention, the cell is part of a film configured according to the first aspect of the present invention.

The present invention provides from a third aspect a laminated glazing comprising a film containing a liquid, a first sheet of glazing material and at least a first sheet of adhesive interlayer material; the film comprising a first substrate joined to a second substrate, the first substrate being spaced apart from the second substrate to define a first cavity in which at least a portion of the liquid is contained; the film being joined to the first sheet of glazing material by the first sheet of adhesive interlayer material; wherein the first sheet of adhesive interlayer material has at least a first void therein, the first void being arranged to accommodate at least a portion of the film into the first void.

By having a first sheet of adhesive interlayer material with a first void therein, if the film shrinks, excess liquid in the film may cause the film to expand into the first void. Preferably the first void is arranged to accommodate at least a portion of the film in the first void by expansion of the film into the first void.

Preferably upon applying a suitable electric field between the first and second substrates, the film changes from a first optical opacity to a second optical opacity.

Preferably a portion of the film is in the first void in the first sheet of adhesive interlayer material.

Preferably a resilient material is contained in the first void in the first sheet of adhesive interlayer material, the resilient material being between the film and the first sheet of glazing material. The resilient material acts as a barrier and is arranged such that if the pressure inside the film becomes too great, the resilient material compresses to allow the film to expand into the first void.

The resilient material may comprise an elastomeric material such as rubber, more preferably silicone rubber.

In some embodiments the liquid comprises a liquid crystal material.

In some embodiments the film comprises at least one weak zone, the weak zone being arranged to communicate with the first void such that upon an increase of pressure within the film the weak zone ruptures and liquid flows into the first void.

In some embodiments a barrier delimits the first void. The use of a barrier to delimit the first void is particularly useful to prevent flow of material from the first sheet of adhesive interlayer material into the first void during lamination of the film, the first sheet of glazing material and the first sheet of adhesive interlayer material at suitably high temperature and/or pressure.

In some embodiments the first sheet of glazing material comprises glass, preferably soda-lime-silicate glass.

In some embodiments the first sheet of adhesive interlayer material comprises polyvinyl butyral (PVB), acoustic modified PVB, a copolymer of ethylene such as ethylene vinyl acetate (EVA), polyurethane (PU), poly vinyl chloride (PVC), a copolymer of ethylene and methacrylic acid (EMA) or a liquid curable resin such as Uvekol.

In some embodiments the laminated glazing comprises a second sheet of glazing material and the film is between the first sheet of glazing material and the second sheet of glazing material.

In some embodiments the laminated glazing comprises a second sheet of adhesive interlayer material and the film is between the first and second sheets of adhesive interlayer material.

In some embodiments the film is positioned in a cut out region of a sheet of adhesive interlayer material. In such embodiments, the film positioned in the cut out region of the sheet of adhesive interlayer material is preferably between the first sheet of adhesive interlayer material and a second sheet of adhesive interlayer material.

In some embodiments the film is configured as a film according to the first aspect of the present invention, wherein the liquid trap is at least partially in the first void.

In some embodiments the film comprises a polarisation layer.

In some embodiments the first sheet of glazing material has a thickness between 1 mm and 5 mm, preferably between 1.3 mm and 3 mm.

In embodiments with a second sheet of glazing material, the preferred thickness of the second sheet of glazing material is between 1 mm and 5 mm, preferably between 1.3 mm and 3 mm.

In some embodiments the laminated glazing is curved in one or more directions. The radius of curvature in one of the one or more directions may be between 1000 mm and 8000 mm.

In some embodiments the first sheet of adhesive interlayer material has a thickness between 0.3 mm and 2.3 mm, more preferably between 0.3 mm and 1.6 mm, most preferably between 0.3 mm and 0.8 mm.

As will be readily apparent, a film according to the first aspect of the present invention may be incorporated into a laminated glazing according to the third aspect of the present invention.

The present invention will now be described with reference to the following figures (not to scale) in which:

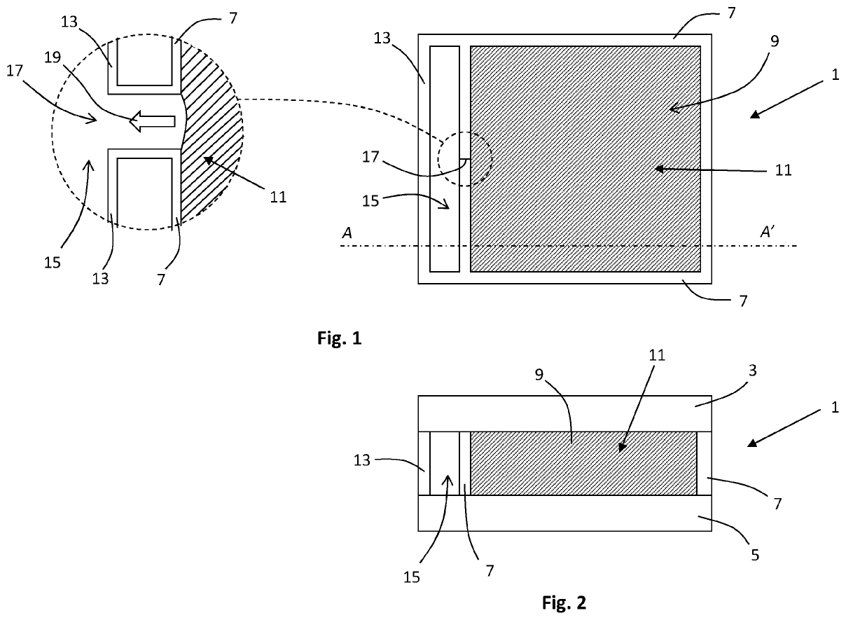

FIG. 1 is a plan view of a film according to the first aspect of the present invention;

FIG. 2 is a schematic cross-sectional view of the laminated glazing shown in FIG. 1 along the line A-A′;

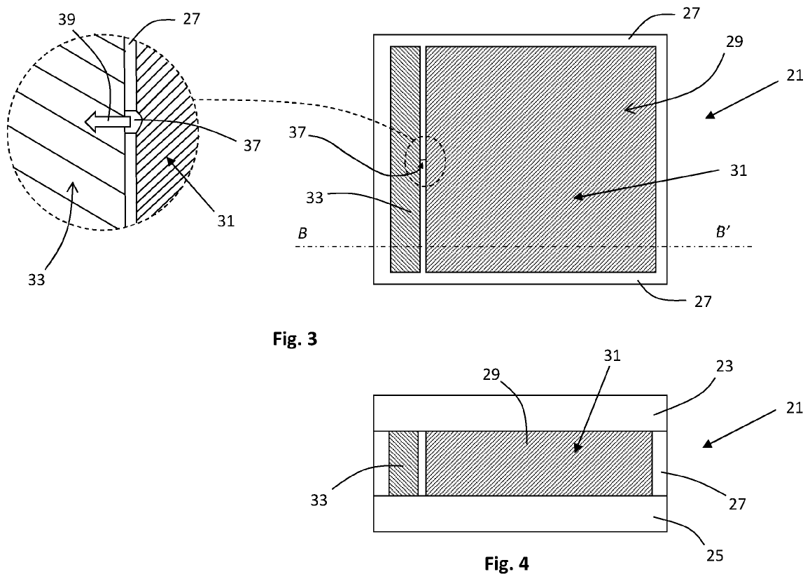

FIG. 3 is a plan view of another film according to the first aspect of the present invention;

FIG. 4 is a schematic cross-sectional view of the laminated glazing shown in FIG. 3 along the line B-B′;

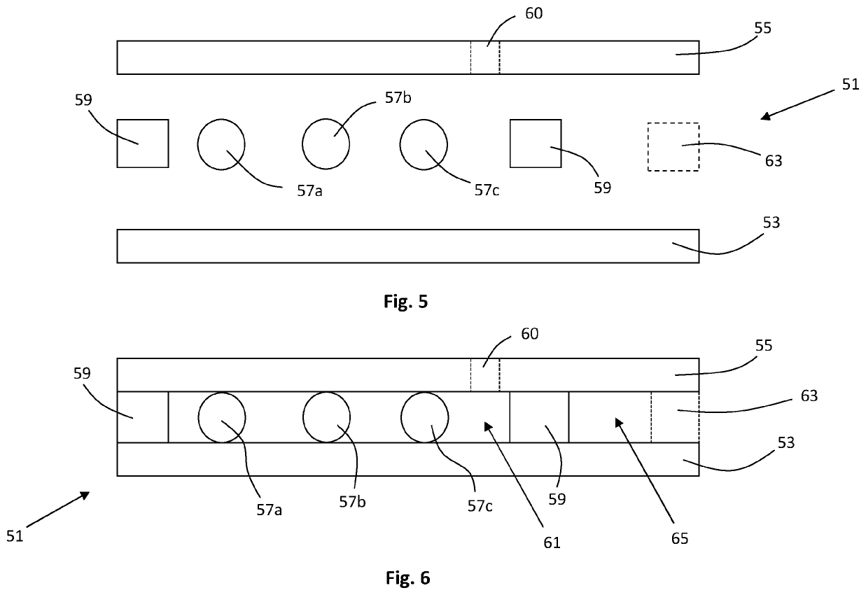

FIG. 5 is a schematic exploded side view of the component parts used to prepare a cell for a liquid in accordance with the second aspect of the present invention;

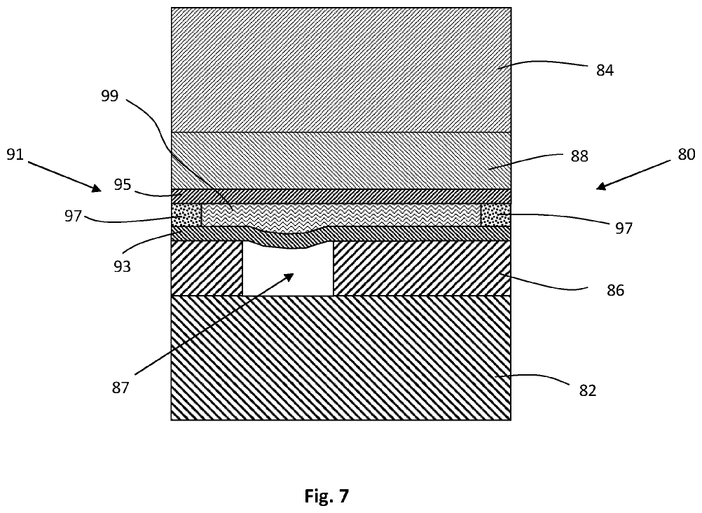

FIG. 6 is a schematic side view of the cell shown in FIG. 5; and

FIG. 7 is schematic cross-sectional view of a laminated glazing according to the third aspect of the present invention.

With reference to FIGS. 1 and 2, there is shown a film 1 comprising a first PET substrate 3 joined to a second PET substrate 5 by a first seal 7. The first seal 7 extends around the periphery of the first and second substrates 3, 5 to define a first cavity 9. Inside the first cavity 9 is a liquid 11. Also located in the first cavity 9 are spherical glass spacers (not shown) to maintain the spacing of the first and second substrates 3, 5.

In this example, the first and second substrates are each about 200 μm thick that are spaced apart by about 50 μm. The spacing may be about 20 μm.

In this example the liquid 11 is a liquid crystal material, for example a guest host liquid crystal material, although the liquid 11 may be any liquid that has variable optical opacity under the action of an electric field. For example, under the influence of a first electric field E₁ having a first magnitude M₁ at a frequency F₁, the optical opacity of the film 1 viewed through the film 1 at normal incidence to the first substrate 3 is O₁, and under the influence of a second electric field E₂ having a second magnitude M₂ at the frequency F₁, the optical opacity of the film 1 viewed through the film 1 at normal incidence to the first substrate 3 is O₂ (the electrical field E₁, E₂ being applied between the first and second substrates 3, 5). Accordingly, the film 1 is a light control film. For example, under the influence of the electric field E₁ the visible light transmission (Illuminant D65 10° Observer) may be greater than 50%, and under the influence of the electric field E₂ the visible light transmission (Illuminant D65 10° Observer) may be less than 50%, for example less than 10%.

As just described, when an electric field is applied between the first and second PET substrates 3, 5, the optical opacity of the layer of liquid 11 in the first cavity changes. Optical wavelengths include at least one wavelength between 380 nm and 780 nm.

Films containing a layer of liquid crystal material are known in the art and may be operated with short switching times i.e. about a second, over a wide temperature range. An alternating voltage may be used to actuate the liquid crystal film to change the optical opacity thereof. In some such films it is known to use a switching voltage that may be 30 V or below and/or a frequency of 50-60 Hz. Liquid crystal films are also known having an operating voltage of 35-70 V AC with an operating frequency of 25-50 Hz square wave.

Also located around the periphery of the first and second substrates 3, 5 is a second seal 13. Inboard of the second seal 13 is a second cavity 15.

To help with clarity, a portion of FIG. 1 is shown in close-up. The first cavity 9 is in fluid communication with the second cavity 15 via an opening 17. The opening 17 is an opening in the first and second seals 7, 13 and provides a path for liquid 11 to flow (in the direction of arrow 19) from the first cavity 9 into the second cavity 15.

In the event of shrinkage of the first and/or second PET substrates 3, 5, the volume of the first cavity 9 is caused to decrease. The pressure inside the first cavity 9 is increased such that liquid 11 may flow into the second cavity 15 via the opening 17.

In this example, the second cavity 15 functions as a liquid trap to contain any liquid that may be caused to flow therein due to the decrease in volume of the first cavity 9 by shrinkage of the first and/or second substrates 3, 5.

In the embodiment shown, the opening 17 is sized such that surface tension is able to prevent the liquid 11 from flowing into the second cavity 15 until a predetermined pressure is created in the first cavity 9.

Liquid may also flow from the first cavity 9 to the second cavity 15 upon applying pressure to the exposed major surface of at least one of the first and second substrates 3, 5.

In an alternative to the embodiment shown in FIGS. 1 and 2, the opening 17 has a barrier to cause the opening to be closed until a sufficient pressure is created in the first cavity 9 to cause the barrier to rupture and liquid 11 to flow through the opening 17 into the second cavity 15. The barrier may be a thin sheet of PET, or may be part of the seal 7, 13 having a suitable thickness.

In another alternative to the embodiment shown in FIGS. 1 and 2, the second cavity has a flexible wall portion, which may be a portion of the second seal 13. The flexible wall portion is able to adjust the volume of second cavity 15 to compensate for pressure differences in the first cavity 9. In such an embodiment the second cavity 15 functions as an expansion vessel or a bladder.

In a similar embodiment to just described, in addition to the walls defining the second cavity 15, a movable wall is included inside the second cavity 15. The movable wall, which may be flexible, functions as a diaphragm in the second cavity to allow the second cavity to compensate for pressure variations in the first cavity.

The film 1 may be included as an interlayer in a laminated glazing. The first substrate 3 may be bonded to a first sheet of glazing material via a first interlayer structure comprising at least one sheet of adhesive interlayer material such as PVB, EVA or PU. The second substrate 5 may be bonded to a second sheet of glazing material via a second interlayer structure comprising at least one sheet of adhesive interlayer material such as PVB, EVA or PU. Such a laminated glazing may be made using conventional lamination techniques.

As the temperature of the film 1 is increased for lamination, the substrates 3, 5 shrink and some of the liquid 11 flows from the first cavity 9 into the second cavity 15 via the opening 17.

The film 1 may be made as follows. Firstly, a first sheet of PET is provided as the first substrate 3. The first sheet of PET may have an electrically conductive, optically transparent coating such as ITO on a major surface thereof.

Next, a first layer of adhesive is provided around the perimeter of one of the major surfaces of the first substrate 3 to produce a receptacle for containing liquid 11. A second layer of adhesive is provided to divide the receptacle into a first region and a second region. Opening 17 is then made in the second layer of adhesive using a blade. Alternatively, the opening 17 may be provided by interrupting the flow of the second layer of adhesive when the receptacle is divided into the first and second regions.

Next, liquid 11 is deposited into the first region, preferably using a one drop filing process.

Next, a second sheet of PET (to provide the second substrate 5) is positioned on the first and second layers of adhesive and caused to become joined thereto. For example, the adhesive may suitably cure by exposure to UV radiation. With the second sheet of PET joined to the first sheet of PET, the liquid in the first region becomes enclosed in a first cavity 9 and the first cavity 9 is in fluid communication with a second cavity 15 via the opening 17. The first cavity includes the first region of the receptacle and the second cavity 15 includes the second region of the receptacle.

As will be readily apparent with reference to FIGS. 1 and 2, the first layer of adhesive gives rise to the second seal 13 and parts of the first seal 7. The second layer of adhesive completes the first seal 7. The layers of adhesive may be applied differently to provide the configuration shown in FIGS. 1 and 2.

The second sheet of PET may have an electrically conductive, optically transparent coating such as ITO on a major surface thereof.

If either or both of the first and second sheets of PET have an electrically conductive, optically transparent coating on a major surface thereof, it is preferred that said coating does not face the first and/or second cavity 9, 15.

With reference to FIGS. 3 and 4, there is shown another film 21 in accordance with the first aspect of the present invention.

The film 21 is similar to the film 1 described above and comprises a first PET substrate 23 joined to a second PET substrate 25 by a first seal 27. The first seal 27 extends around the periphery of the first and second substrates 23, 25 to define a first cavity 29. Inside the first cavity 29 is a liquid 31. Also located in the first cavity 29 are spherical glass spacers (not shown) to maintain the spacing of the first and second substrates 23, 25.

In this example, the first and second substrates are each about 100 μm thick that are spaced apart by about 25 μm.

Located between the first and second substrates 23, 25 is a liquid absorber in the form of a sponge 33.

To help with clarity, a portion of FIG. 3 is shown in close-up.

The sponge 33 is adjacent a portion of the seal 27. In the portion of the seal 27 that is adjacent the sponge 33 is an opening 37. The opening 37 provides a path for liquid 31 to flow (in the direction of arrow 39) from the first cavity 29 into the sponge 33.

In the event of shrinkage of the first and/or second PET substrates 23, 25, the volume of the first cavity 29 is caused to decrease. The pressure inside the first cavity 29 is increased such that liquid 31 may flow through the opening 37 to be absorbed by the sponge 33.

In this example, the sponge function as a liquid trap to contain any liquid that may be caused to flow therein due to the decrease in volume of the first cavity 29 by shrinkage of the first and/or second substrates 23, 25. Although in this example the sponge is shown along one edge of the first cavity 29, the sponge may be along two or more edges of the first cavity 29. In some embodiments, the sponge surrounds the first cavity 29 with openings being provided at one or more side to help improve the flow of liquid to the sponge.

In the embodiment shown, the opening 37 is sized such that surface tension is able to prevent the liquid 31 from flowing into the sponge 33 until a predetermined pressure is created in the first cavity 29.

The sponge 33 may be contained in a second cavity of the type described above with reference to FIGS. 1 and 2.

With reference to FIGS. 5 and 6, a method of preparing a cell 41 for a liquid such as a liquid crystal material is described. The cell 51 comprises a first substrate 53 joined to a second substrate 55. In this example the first and second substrates 53, 55 are sheets of PET that are each about 100 μm thick.

To prepare the cell 51 for a liquid, the first substrate 51 is laid out horizontally. In this example, a plurality of spacers (only three are shown and labelled 57a, 57b, 57c) are then laid onto the upper facing major surface of the first substrate. The spacers 57a, 57b, 57c are glass spheres having a diameter that determines the spacing of the cell 51.

Next a layer of adhesive 59 is deposited on the upper facing major surface of the first substrate 53. The layer of adhesive 59 surrounds the plurality of spacers and is used to define the wall of a first cavity 61.

Next the second substrate 55 is positioned on the first substrate 53 to contact the layer adhesive 59 and the spacers 57a, 57b, 57c.

In this example the second substrate 55 has a hole 60 extending between opposing major surfaces thereof.

The layer of adhesive 59 is then allowed to cure such to form the cell 51 having a first cavity 61 having a first volume. The cured layer of adhesive 59 joins the first substrate 53 to the second substrate 55 and acts as a seal between the cavity and the outside environment.

The cell 51 is then heated at a temperature of about 150° C. for about one hour to cause the first and second substrates 53, 55 to shrink. The shrinkage of the substrates causes the volume of the cavity 61 to decrease from the first volume to a second volume. Other times and temperatures may be determined by experiment.

The cell 51 has then been prepared and may be used to contain a liquid in the cavity 61. Liquid may be introduced into the cavity 61 via the hole 60. The hole 60 may be sealed thereafter.

The cell 51 that has been prepared according to the second aspect of the present invention has already undergone shrinkage so that when the cell 51 having liquid in the cavity thereof is used in a subsequent process involving increasing the temperature of the cell 51, there is little, if any shrinkage of the first and second substrates 53, 55.

A subsequent process is a lamination process where the cell 51 may be laminated between two sheets of glass using sheets of PVB either side of the cell 51.

Also shown in FIGS. 5 and 6 is the option provision of a second layer of adhesive 63 used to define a second cavity 65. Such a cell is useful in making a film in accordance with the first aspect of the present invention. In embodiments having a second cavity in fluid communication with a first cavity, the method may not include a heating step to pre-shrink the cell.

In an alternative to the method described above, a second substrate is provided without a hole 60 therein. In such an embodiment, the liquid to be contained in the cavity is introduced before the second substrate is positioned on the first substrate. The amount of liquid introduced is less than the volume of the cavity 61 produced. However, when the cavity 61 decreases in volume due to the shrinkage of the first and second substrates 53, 55, the amount of liquid is sufficient to completely fill the cavity having the second volume.

In such an embodiment, the heating step to cause the cavity 61 to decrease in volume may be part of another processing step, for example a lamination step.

FIG. 7 shows a laminated glazing 80 in accordance with the third aspect of the present invention.

The laminated glazing 80 comprises a first sheet of glass 82 and a second sheet of glass 84. Between the first and second sheets of glass 82, 84 are a first sheet of PVB 86, a second sheet of PVB 88 and a film 91. The film 91 is between the first and second sheets of PVB 86, 88. The first sheet of PVB 86 is between the film 91 and the first sheet of glass 82. The second sheet of PVB 88 is between the film 91 and the second sheet of glass 84. The sheets of PVB 86, 88 are about 0.8 mm thick i.e. between about and about 0.8 mm thick.

The film 91 comprises a first PET substrate 93 spaced apart from a second PET substrate 95. The first PET substrate 93 is joined to the second PET substrate 95 by a seal 97. The seal 97 extends around the periphery of the inner facing major surfaces of the first and second PET substrates 93, 95. A suitable seal 97 is a cured epoxy.

A first cavity is defined by the inner facing major surfaces of the first and second PET substrates 93, 95 and the seal 97. A liquid 99 is contained in the first cavity just described.

The first sheet of PVB 86 has a void 87 therein. The void 87 may be made by stamping out a portion of the first sheet of PVB 86. A barrier material (not shown) may be used to delimit the void 87. A suitable barrier material is PET tape which may be used to cover the edges of the PVB facing into the void 87 and prevents PVB flow into the void during lamination.

The laminated glazing 80 is made using a conventional lamination process, using a suitably high pressure and a suitably high temperature, for example between 80° C. and 150° C.

The high temperature during lamination may cause the first and second substrates 93, 95 of the film 91 to shrink. In order to accommodate the increased pressure that is caused in the cavity of the film 91, the film 91 may expand into the void 87 in the first sheet of PVB 86.

In an alternative example to that shown in FIG. 7, the first substrate 93 of the film 91 has weak zones in the vicinity of the void 87, for example localised thickness variations in the first substrate 93. Upon increasing pressure in the cavity of the film 91, the weak zones cause the first substrate 93 to rupture thereby allowing some liquid 99 to flow into the void 87.

In another alternative example to that shown in FIG. 7, an elastomeric material is positioned in the void 87 to provide resistance to the film 91 from expanding into the void. Expansion of the film into the void 87 is only possible once a predetermined pressure in the first cavity of the film 91 has been exceeded.

In the previous examples, the liquid may be a liquid crystal containing material. In such embodiments, the first and second substrates of the film and/or cell may also include suitable electrodes (i.e. ITO coating layers or other suitable electrically conductive coating that is preferably optically transparent), a polarisation layer and alignment layers as known in the art.

The present invention is particularly useful for films that undergo shrinkage when heated. The heating may be part of a process to incorporate the film into another product such as a laminated glazing.

1. A film containing a liquid, the film comprising a first substrate joined to a second substrate, the first substrate being spaced apart from the second substrate to define a first cavity in which at least a portion of the liquid is contained, wherein upon applying a suitable electric field between the first and second substrates, the film changes from a first optical opacity to a second optical opacity, characterised in that the film comprises a liquid trap configured to be in fluid communication with the first cavity via at least a first opening, the liquid trap being arranged to contain liquid that flows from the first cavity through the first opening.

2. A film according to claim 1, wherein the liquid trap comprises a second cavity and liquid that passes through the first opening is containable in the second cavity.

3. A film according to claim 2, wherein the second cavity has an internal pressure less than atmospheric pressure and/or wherein the second cavity is configured as a channel having a length, a width and a height, the height of the channel being determined the spacing of the first and second substrates of the film.

4. A film according to claim 2, wherein the second cavity is configured as an expansion vessel to compensate for pressure changes inside the first cavity.

5. A film according to claim 4, wherein the expansion vessel has at least a first wall portion and wherein the first wall portion of the expansion vessel is movable and/or flexible and/or located inside the second cavity.

6. A film according to claim 1, wherein the liquid trap comprises a liquid absorber for containing liquid that passes through the first opening therein.

7. A film according to claim 1, wherein the first opening is configured such that for a predetermined pressure inside the first cavity, liquid is inhibited from flowing from the first cavity to the liquid traps.

8. (canceled)

9. A film according to claim 1, wherein the first and/or second substrate comprises a heat shrinkable material.

10. (canceled)

11. (canceled)

12. (canceled)

13. (canceled)

14. A laminated glazing comprising a film according to claim 1, the film being joined to a first sheet of glazing material by a first adhesive layer or a first sheet of adhesive interlayer material.

15. (canceled)

16. (canceled)

17. A method of preparing a cell for a liquid, the cell comprising a first substrate joined to a second substrate, the first and/or second substrate comprising a heat shrinkable material; the method comprising:
(i) providing the first substrate;
(ii) positioning the second substrate on the first substrate such that the first substrate is spaced apart from the second substrate;
(iii) forming the cell by joining the second substrate to the first substrate to form a cavity having a first volume; and
(iv) heating the cell formed at (iii) to cause the first volume of the cavity to decrease to a second volume.

18. (canceled)

19. (canceled)

20. A method according to claim 17, wherein the cell formed at (iii) has at least one hole therein in fluid communication with the cavity, and following (iv) liquid is introduced into the cavity via the hole, after which the hole is sealed thereby sealing liquid in the cavity of the cell.

21. (canceled)

22. A method according to claim 17, wherein after (i) a first amount of liquid is positioned on the first substrate, the first amount of liquid having a volume less than the first volume of the cavity.

23. (canceled)

24. (canceled)

25. (canceled)

26. A method according to claim 17, wherein the heating during (iv) is part of a lamination process whereby the cell is laminated to at least one sheet of glazing material by at least one sheet of adhesive interlayer material and/or wherein the heating during (iv) is part of a pre-processing step such that following (iv), the heat processed cell is used as a component of a laminated glazing comprising at least one sheet of glazing material and at least one sheet of adhesive interlayer material, the cell being joined to the at least one sheet of glazing material by the at least one sheet of adhesive interlayer material.

27. A laminated glazing comprising a film containing a liquid, a first sheet of glazing material and a first sheet of adhesive interlayer material;
the film comprising a first substrate joined to a second substrate, the first substrate being spaced apart from the second substrate to define a first cavity in which at least a portion of the liquid is contained;
the film being joined to the first sheet of glazing material by the first sheet of adhesive interlayer material;
wherein the first sheet of adhesive interlayer material has at least a first void therein, the first void being arranged to accommodate at least a portion of the film into the first void.

28. A laminated glazing according to claim 27, wherein the first void is arranged to accommodate at least a portion of the film in the first void by expansion of the film into the first void

29. A laminated glazing according to claim 27, wherein a portion of the film is in the first void in the first sheet of adhesive interlayer material.

30. A laminated glazing according to claim 27, wherein a resilient material is contained in the first void, the resilient material being between the film and the first sheet of glazing material.

31. A laminated glazing according to claim 27, wherein the film comprises at least one weak zone, the weak zone being arranged to communicate with the first void such that upon an increase of pressure within the film the weak zone ruptures and liquid flows into the first void.

32. A laminated glazing according to claim 27, wherein a barrier delimits the first void such that adhesive interlayer material from the first sheet of adhesive interlayer material is prevented from flowing into the first void.

33. A laminated glazing according to claim 27, wherein the film changes from a first optical opacity to a second optical opacity upon applying an electric field between the first and second substrates, the film also comprising a liquid trap configured to be in flux communication with the first cavity via at feast a first opening, the liquid trap being arranged to contain liquid that flows from the first cavity through the first opening the liquid trap being at least partially in the first void.
